(19) United States
(12) Patent Application Publication
(10) Pub. No.: US 2025/0235066 A1
(43) Pub. Date: Jul. 24, 2025

(54) WET/DRY VACUUM TOOLS WITH SIMPLIFIED CONTAINMENT TOOLS AND COOPERATING TOOL SETS

(71) Applicant: SHARKNINJA OPERATING LLC, Needham, MA (US)

(72) Inventors: Lee M. COTTRELL, Edenbridge (GB); Robert BONE, Stoughton, MA (US)

(21) Appl. No.: 18/417,728

(22) Filed: Jan. 19, 2024

(51) Int. Cl. A47L 11/40; A47L 11/30; A47L 11/34

(52) U.S. Cl. CPC A47L 11/4044; A47L 11/30; A47L 11/34; A47L 11/4016; A47L 11/4027; A47L 11/4083; A47L 11/4088

(57) ABSTRACT

The present disclosure is generally directed to vacuum tools. In one example, a first wet/dry crevice tool is provided that can be coupled to a vacuum source and a cleaning fluid source. The first tool includes a vacuum orifice and a cleaning fluid nozzle assembly coupled to a cleaning fluid actuation mechanism to controllably deliver cleaning fluid to a target area to be cleaned. The vacuum orifice is configured to sealingly interface with another cooperating tool. The first tool includes latching mechanisms and tolerance rails to enable secure coupling of the first tool to another cooperating tool, for example a wet/dry containment tool.

### TECHNICAL FIELD

The present disclosure is generally directed to wet/dry vacuum tools, and more particularly to cooperating wet/dry vacuum tools with simplified containment tools and cooperating tool sets.

### BRIEF DESCRIPTION OF THE DRAWINGS

These and other features and advantages will be better understood by reading the following detailed description, taken together with the drawings, wherein:

FIG. 1A illustrates a perspective side view of a first wet/dry vacuum tool according to embodiments of the present disclosure;

FIG. 1B illustrates another perspective side view of the first tool according to embodiments of the present disclosure;

FIG. 1C illustrates a perspective view of the back end of the first wet/dry vacuum tool according to embodiments of the present disclosure;

FIG. 1D illustrates a close-up perspective view of the wet/dry region of the first wet/dry vacuum tool according to embodiments of the present disclosure;

FIG. 1E illustrates another perspective side view of the first wet/dry vacuum tool according to embodiments of the present disclosure;

FIG. 1F illustrates a close-up cross-sectional view of the wet/dry region of the first wet/dry vacuum tool, taken along the line X-X in FIG. 1E, according to embodiments of the present disclosure;

FIG. 1G illustrates another close-up cross-sectional view of the wet/dry region of the first wet/dry vacuum tool, taken along the line X-X in FIG. 1E, according to embodiments of the present disclosure;

FIG. 2A illustrates a side perspective view of a second wet/dry vacuum tool according to embodiments of the present disclosure;

FIG. 2B illustrates a front perspective view of the containment tool according to embodiments of the present disclosure;

FIG. 2C illustrates a front perspective and partially exploded view of the containment tool 200 according to embodiments of the present disclosure;

FIG. 2D illustrates a back perspective view of the containment tool according to embodiments of the present disclosure;

FIG. 2E illustrates a back perspective and partial cut-away view of the containment tool according to embodiments of the present disclosure;

FIG. 2F illustrates another back perspective view of the containment tool according to embodiments of the present disclosure;

FIG. 2G illustrates another perspective side view of the containment tool according to embodiments of the present disclosure;

FIG. 2H illustrates a cross-sectional view of the containment tool, taken along the line XI-XI in FIG. 2G, according to embodiments of the present disclosure;

FIG. 2I illustrates a bottom perspective view of the containment tool according to embodiments of the present disclosure;

FIG. 2J illustrates a side perspective view of the containment tool according to another embodiment of the present disclosure;

FIG. 2K illustrates a side perspective view of the containment tool of FIG. 2J;

FIG. 3A illustrates a perspective side view of a cooperating tool set according to embodiments of the present disclosure;

FIG. 3B illustrates a cross-sectional view of the cooperating tool set, taken along the line XI-XI in FIG. 3A, according to embodiments of the present disclosure;

FIG. 4A illustrates a perspective side view of another containment tool according to embodiments of the present disclosure;

FIG. 4B illustrates a cross-sectional view of the containment tool, taken along the line XIII-XIII in FIG. 4A, according to embodiments of the present disclosure;

FIG. 4C illustrates a bottom perspective view of a containment tool according to one embodiment;

FIG. 4D illustrates a cross sectional view of another embodiment of the containment tool;

FIG. 5 illustrates a schematic example of a handheld extraction cleaner consistent with embodiments of the present disclosure; and

FIG. 6 illustrates a schematic example of an upright extraction cleaner consistent with embodiments of the present disclosure.

### DETAILED DESCRIPTION

The present disclosure is generally directed to vacuum tools. In one example, a first wet/dry crevice tool is provided that can be coupled to a vacuum source and a cleaning fluid source. The first tool includes a vacuum orifice and a cleaning fluid nozzle assembly coupled to a cleaning fluid actuation mechanism to controllably deliver cleaning fluid to a target area to be cleaned. The vacuum orifice and the cleaning fluid nozzle assembly are configured to sealingly interface with another cooperating tool. The first tool includes latching mechanisms and tolerance rails to enable secure coupling of the first tool to another cooperating tool, for example a liquid containment tool. In another example, a liquid containment tool is provided that includes a cleaning fluid interface to sealingly couple to the nozzle assembly of the crevice tool and a vacuum interface to sealingly couple to the vacuum orifice of the crevice tool. The containment tool includes a vacuum orifice fluidly coupled to the vacuum interface, thus receiving suction at the vacuum orifice of the containment tool. The containment tool includes a liquid spray nozzle and conduit coupled between the cleaning fluid interface and the liquid spray nozzle to controllably deliver cleaning fluid by the containment tool. The first tool and the liquid containment tool are configured to attach together and cooperate to perform a variety of cleaning tasks. The wet/dry tool described herein may be coupled to a variety of wet/dry extraction cleaners, and the wet/dry tools described herein may be used with a variety of cleaning solutions, depending on the cleaning task.

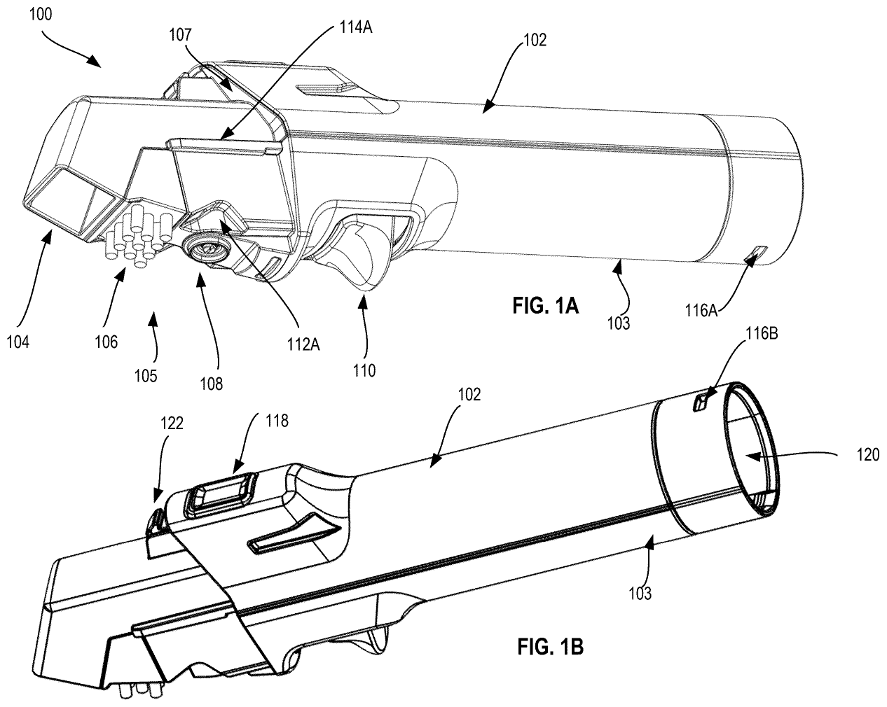

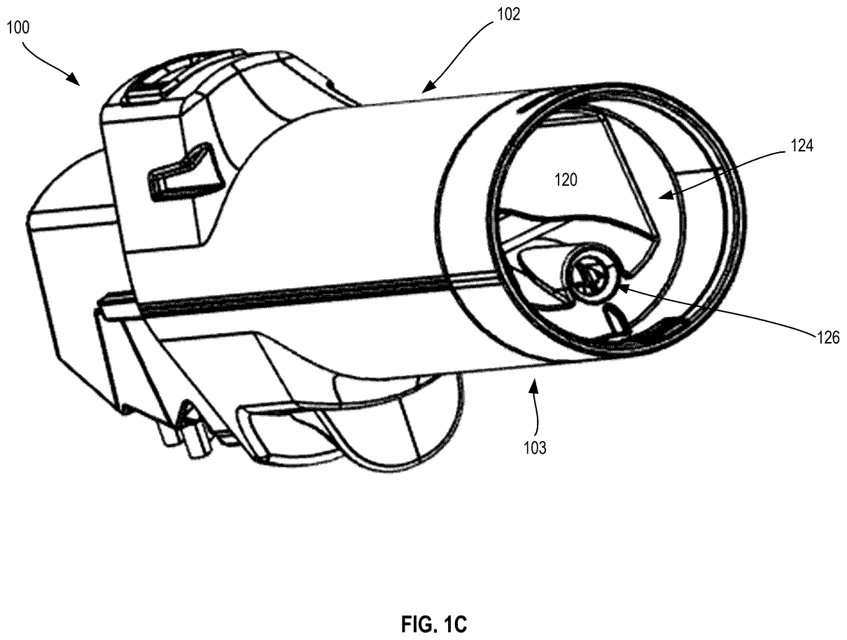

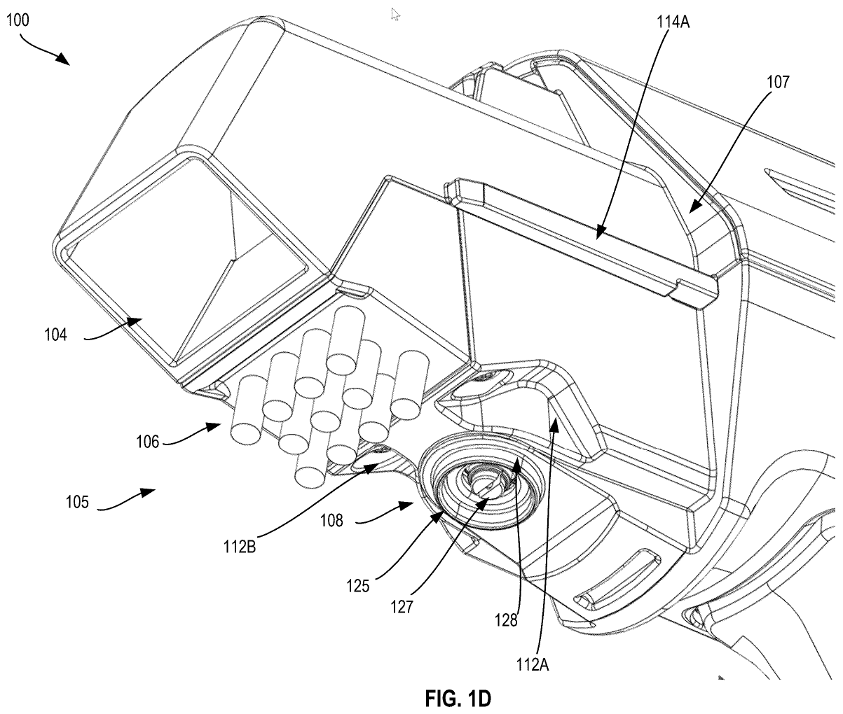

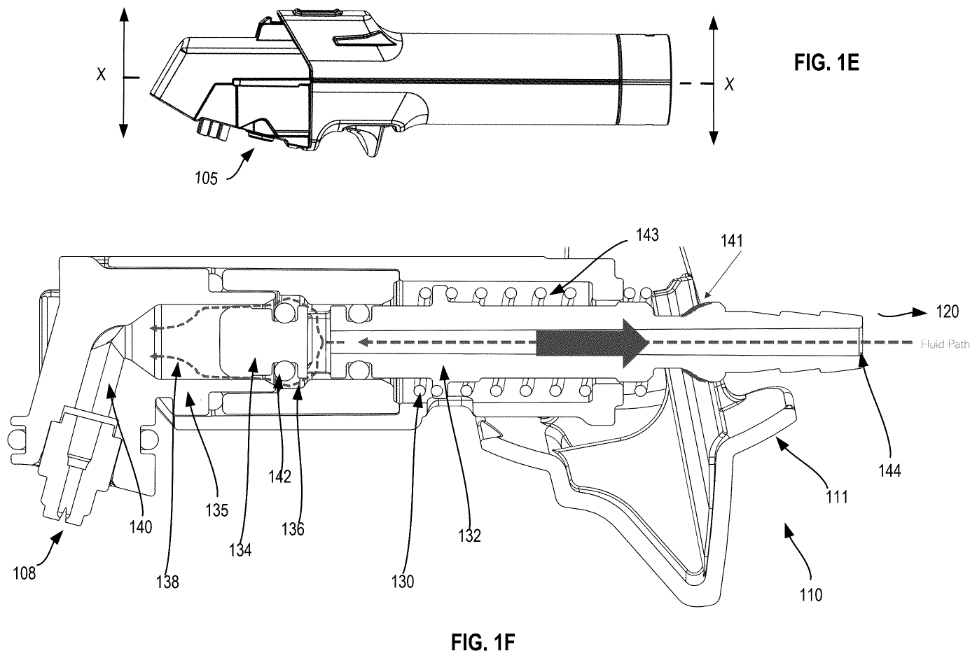

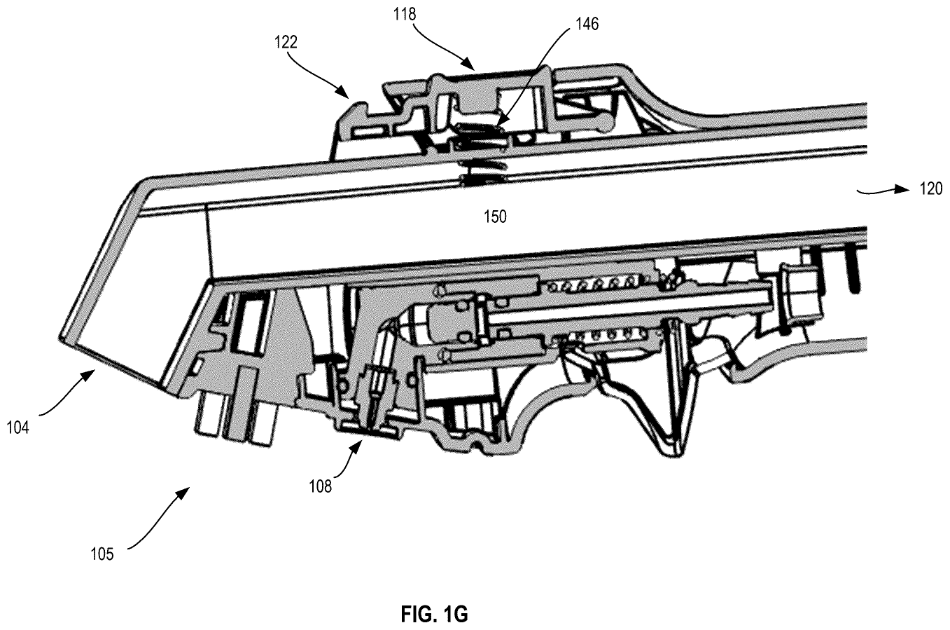

FIG. 1A illustrates a perspective side view of a first wet/dry vacuum tool 100 (hereafter “crevice tool 100”) according to embodiments of the present disclosure. The crevice tool 100 includes a body 102 that includes a grip region 103 on one end of the body 102 and a wet/dry cleaning region 105 on an opposing end of the body 102. The grip region 103 has a generally circular cross section dimensioned to be gripped by a user during operation of the crevice tool 100. The body 102 also includes an abutment region 107 between the wet/dry cleaning region 105 and the grip 103, where the abutment region 107 includes one or more surfaces to receive a different tool to be placed over the wet/dry region 105, as will be described in greater detail below.

The wet dry/region 105 of the body 102 includes an airflow orifice (vacuum orifice) 104 defined at an end of the body 102 and directed toward an underside of the body 102, agitator assembly 106 generally disposed adjacent the vacuum orifice 104 on the underside of the body 102, and a fluid dispensing nozzle assembly 108 disposed adjacent to the agitator assembly 106. The vacuum orifice 104 is in fluid communication through the body 102 and to the opposing end of the body (the end of the grip region 103) so that when the tool 100 is coupled to a vacuum source hose (not shown), suction is applied to the vacuum orifice 104. The vacuum orifice 104 is depicted as having a generally rectangular cross section, although in some embodiments the vacuum orifice may have a generally circular cross section, generally oval cross section, triangular cross section, elongated cross section, etc. The agitator assembly 106 generally includes a plurality of filaments (e.g., elongated filaments) extending from the body 102. The filaments may be formed of, for example, plastic, rubber, composite material, metal, metal composites, etc. In some embodiments, the plurality of filaments may be selected for a desired stiffness, length and/or density for a given cleaning task. Also, in some embodiments the agitator assembly 106 may be removably coupled to the body 102, thus allowing interchangeable agitator assemblies to be coupled to the body 102 for a given cleaning task. The nozzle assembly 108 generally includes a liquid spray nozzle and flanged housing, described in greater detail below.

The body 102 also includes a cleaning fluid actuator 110 generally configured to permit a user to controllably apply cleaning fluid (from a fluid source hose, not shown in this figure) through the fluid nozzle assembly 108. As illustrated, the cleaning fluid actuator 110 may include a trigger button having a form factor to fit a human finger to start and stop liquid flow from the nozzle. As will be described in greater detail below, the cleaning fluid actuator 110 may be biased to a closed (or “off” position), thus preventing fluid flow through the nozzle assembly 108 (and thus reducing unintentional discharge of liquid).

To enable fitted cooperation of the crevice tool 100 with another tool (e.g., a liquid containment tool, wet/dry containment tool, each described below), the body 102 of the crevice tool 100 may include one or more mating features to mate with another tool and to provide locking engagement with the other tool. For example, and will be described in greater detail below, the body may include one or more recesses (one of which is shown at 112A in FIG. 1A) on either side of the body 102 to mate with one or more protrusions of the other tool. In addition, the body 102 may also include rails and/or slots (e.g., rail 114A, with a matching rail/slot on the other side of the body 102) on either side of the body 102 to mate with a slot and/or rail of the other tool. To securely connect the grip region 103 to vacuum/liquid hoses (not shown in this figure), the end of the body may include one or more slots and/or indents 116A to mate with corresponding indents/slots of the vacuum/liquid hoses.

FIG. 1B illustrates another perspective side view of the crevice tool 100 according to embodiments of the present disclosure. As illustrated in this view, the body 102 may also include a connection latch 122 to latch to another tool (not shown in this figure). An actuation button 118 may be engaged by a user to cause the latch to engage/disengage from the other tool. The latch 122 is illustrated as a moveable “hook” to slidably engage and disengage from another tool, and the actuation button 118 may include a spring mechanism (not shown in this figure) to bias the actuation latch 122 to a locked position when engaged with another tool. The actuation latch 122 and user button 118 are illustrated as being disposed generally on the “top” of the body 102, however, in other embodiments the latch 122/button 118 may be disposed at other locations along the periphery of the body 102. As is also illustrated in this view, an opening 120 is defined at the end of the grip region 103 to interface with liquid/vacuum hoses. As is illustrated, the area around the opening 120 may include addition slots/indents (e.g., slot 116B to securely engage the end of a vacuum hose).

FIG. 1C illustrates a perspective view of the back end of the crevice tool 100 according to embodiments of the present disclosure. As illustrated in this view, the grip region 103 of the body 102 defines interface abutment surface(s) 124 within the well of opening 120 to provide an end stop when the end of a vacuum hose is inserted into the opening 120. Within the opening, a liquid connection interface 126 may be provided to couple to a liquid hose line (not shown in this figure). The liquid connection interface 126 may include internal “ridges” and/or ribs to provide a “snap-fit” and water-tight seal with a liquid hose line (and the liquid hose line may include an engagement end that includes seals (e.g., O-Rings, etc.) to seal within the interface 126. While the body 102 at the end of the grip region 103 is illustrated as having a generally circular cross section, in other embodiments, the opening 120 may be defined as having different shapes, for example, rectangular, oval, irregular, etc. Also, the dimensions of the opening 120 may be defined to interface with a plurality of vacuum hose types, which may include, conventional and/or custom and/or proprietary vacuum hoses.

FIG. 1D illustrates a close-up perspective view of the wet/dry region 105 of the tool 100 according to embodiments of the present disclosure. As illustrated, the nozzle assembly 108 includes a flanged ring 125 surrounding a liquid dispensing nozzle 127. The flanged ring 125 includes sidewall portions 128 that are generally dimensioned to interface with a corresponding liquid interface of another tool, and to provide a liquid-tight seal with the liquid interface of another tool (all described in greater detail below). Also illustrated in this view are recesses 112A and 112B defined on either side of the nozzle assembly 108, described above. Other features illustrated in this view include the engagement rail 114A, abutment surface 107, vacuum orifice 104 and agitator assembly 106, each described above.

FIG. 1E illustrates another perspective side view of the crevice tool 100, and FIG. 1F illustrates a close-up cross-sectional view of the wet/dry region 105, taken along the line X-X in FIG. 1E. As illustrated in FIG. 1F, the cleaning fluid actuator 110 includes a movable trigger actuator 111. The trigger actuator 111 is coupled to a piston conduit 132 (for example, coupled at shoulder point 141). A trigger spring 130 is coupled to (e.g., surrounding) a portion of the piston conduit 132. The piston conduit 132 and spring 130 are contained within a piston chamber 143, to enable compression and release of the spring 130. The piston conduit 132 is coupled to a release valve 134 disposed in a sealed housing 135 defined in the body 102. The release valve 134 permits liquid to flow into a chamber 138 and into a nozzle conduit 140. The nozzle conduit 140 is disposed in a sealed chamber, and, in a closed or off position, a gasket (or O-ring) 142 provides a liquid-tight seal for the nozzle conduit 140. The sealed chamber 135 includes recesses 136 to receive gasket 142 when the piston conduit 132 and release valve 134 are moved to a rear position, thus allowing fluid flow through the piston conduit 132 and around the release valve 134 and gasket 142, as illustrated by the fluid flow path in FIG. 1F. The piston conduit 132 is also sealably coupled to a liquid conduit connection 144 (which itself is coupled, via a conduit (not shown), to the liquid connection interface 126).

In operation, when a user pulls the movable trigger actuator 111 rearward, the piston conduit 132 and release valve 134 are urged rearward, the gasket 142 aligns with recesses 136, thus allowing liquid to flow through the piston conduit 132 (via the liquid connection interface 120) and around the release valve 134 and gasket 142 and into the chamber 138. In some embodiments, the chamber 138 has a greater volume (i.e., greater cross-sectional surface area) than the nozzle conduit 140, thus providing an increase in pressure as liquid moves into the nozzle conduit 140 and out through the nozzle assembly 108. In addition, in some embodiments, the nozzle conduit 140 may be tapered from the chamber 138 to the nozzle, thus providing additional pressure increase. When the user releases the trigger actuator 111, the trigger spring 130 causes the piston conduit 132 and release valve 134 to move forward, thus sealing the chamber 138 from liquid flow (in other words, the trigger spring 130 biases the piston conduit 132 and release valve 134 to an “off” position to prevent unintentional liquid discharge).

FIG. 1G illustrates another close-up cross-sectional view of the wet/dry region 105, taken along the line X-X in FIG. 1E. As illustrated in the view of FIG. 1G, a latch spring 146 is coupled to latch release button 118. As illustrated, the latch release button 118 is coupled to the latch 122. The latch spring 146 extends from a platform formed in the internal structure of the body, and is biased to urge the latch release button 118 upward, thus causing the latch 122 to remain in a locked position. Pushing the latch release button 118 downward causes the latch 122 to move downward, thus disengaging a tool coupled to the latch 122.

A vacuum airflow conduit 150 is defined in the body 102 between the vacuum orifice 104 and the rear vacuum hose connection interface (defined in opening 120). Thus, in this example embodiment, the vacuum airflow conduit 150 is disposed above the cleaning fluid conduit (between interface 126 and conduit connection 144). In other embodiments, the body 102 may include routing chambers, conduits, and/or shafts to fluidly couple airflow and cleaning fluid from the back end of the tool body 102 to the vacuum orifice 104 and nozzle assembly 108.

As is illustrated, the internal structure of the body 102 includes various slots, channels and/or chambers to affix and/or house the trigger actuator 111, piston conduit 132, trigger spring 130, release valve 134, nozzle conduit 140, gasket 142, and liquid conduit connection 144 within the body 102. Of course, such slots, channels and/or chambers to affix and/or house components within the body may be modified, for example, depending on dimensions of selected components, desired tolerances within the body and between components, etc.

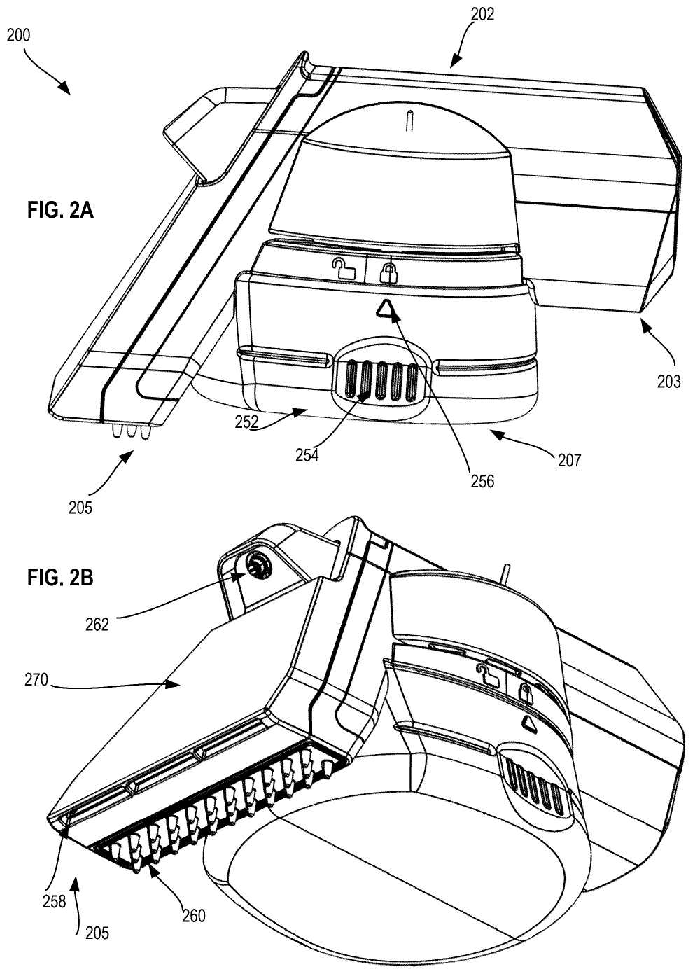

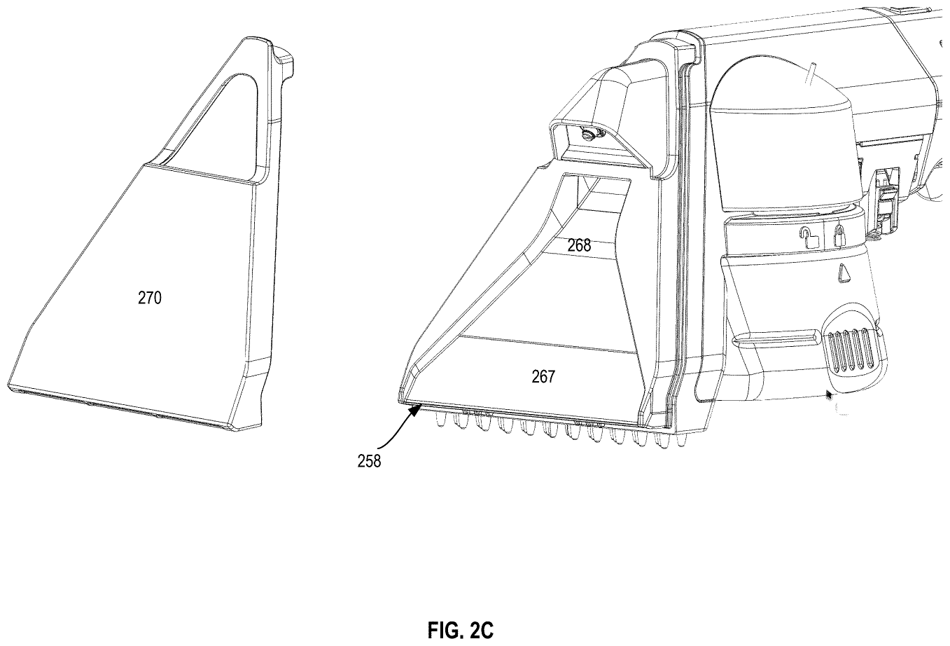

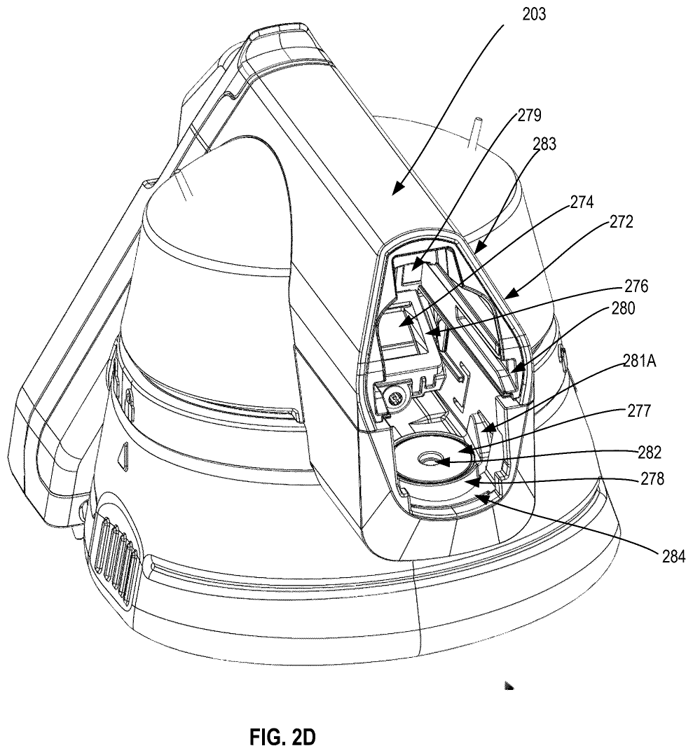

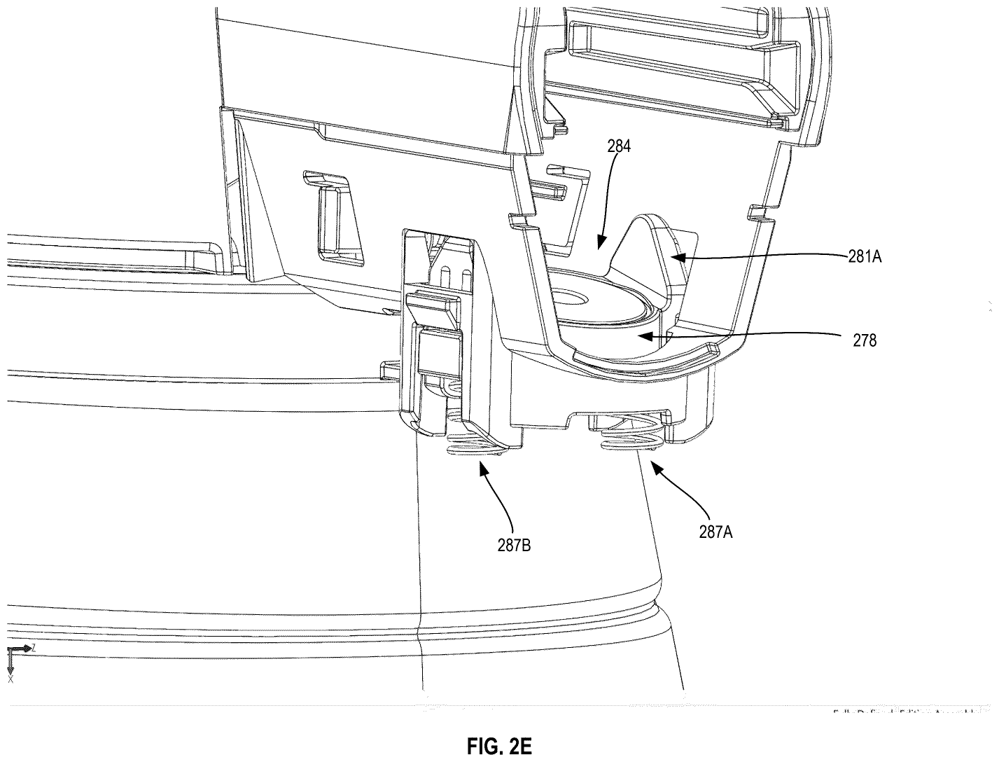

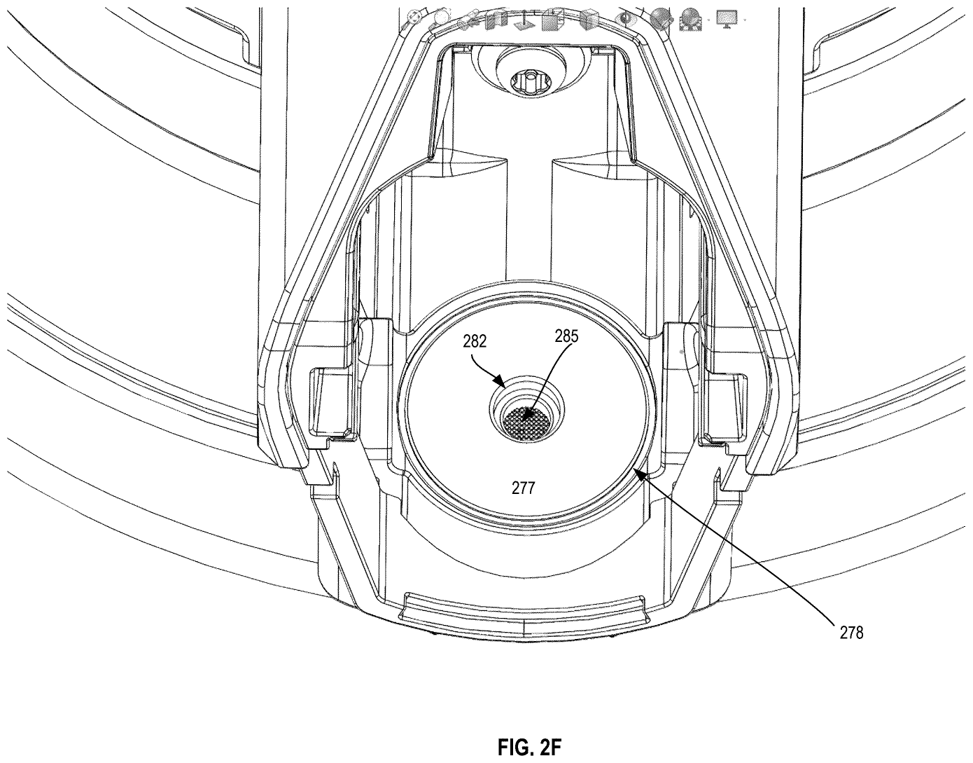

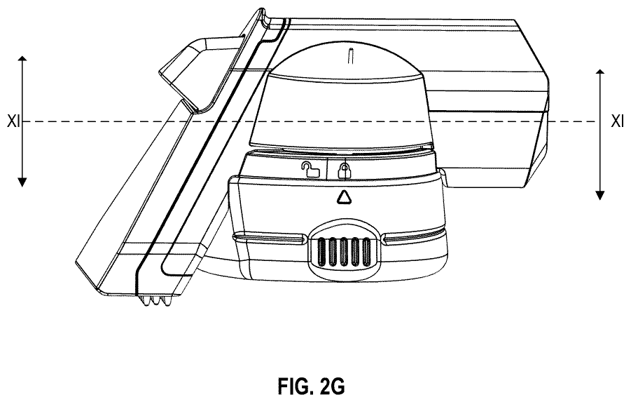

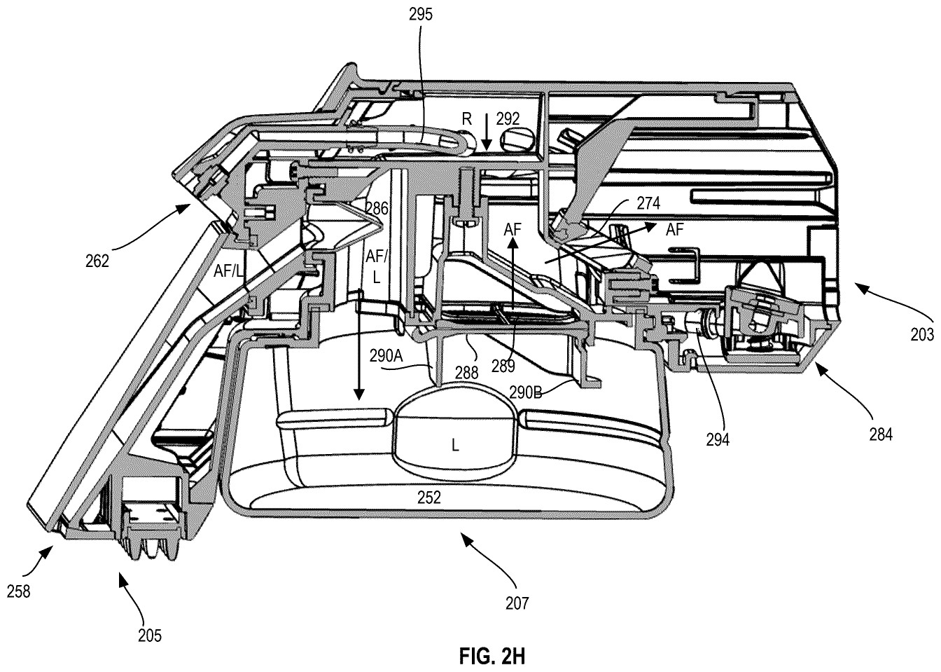

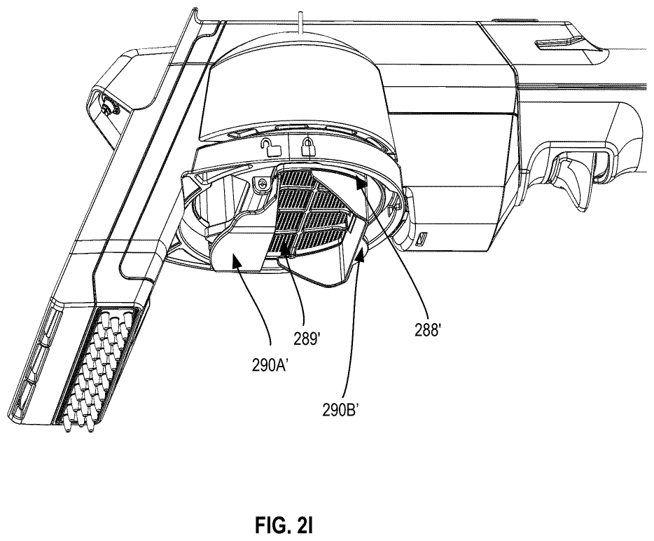

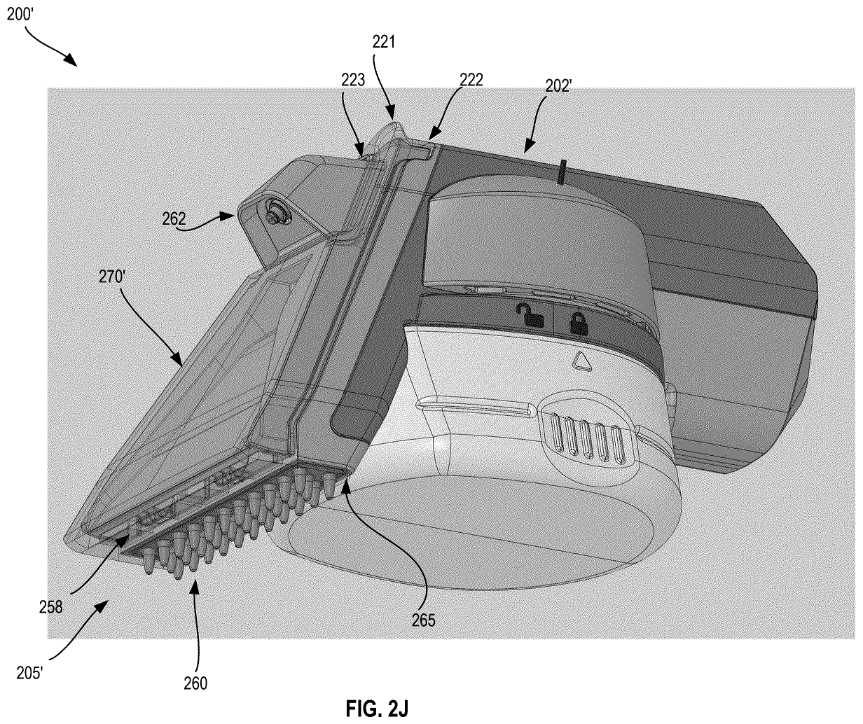

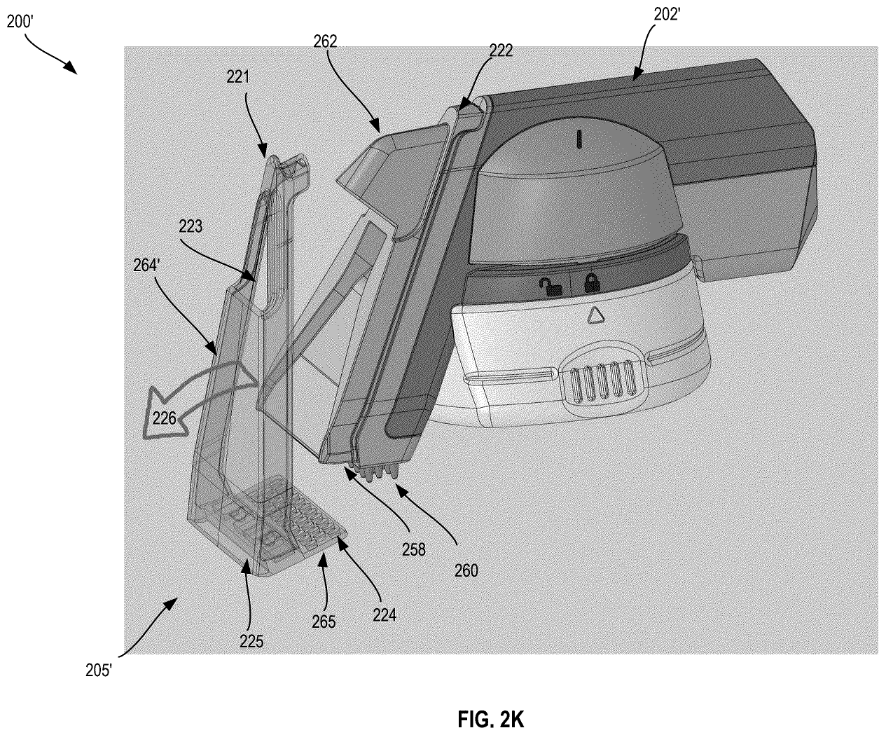

FIG. 2A illustrates a side perspective view of a second wet/dry vacuum tool 200 (hereafter “liquid containment tool 200” or “containment tool 200”) according to embodiments of the present disclosure. As a general matter, the containment tool 200 of FIG. 2 is configured to engage over a portion of the crevice tool 100 of FIG. 1 (described above), thus providing a cooperating tool set for a variety of wet/dry cleaning tasks. The containment tool 200 generally includes a body 202 that includes an interface region 203 on one end of the body 202, a wet/dry cleaning region 205 on an opposing end of the body 202, and a liquid containment region 207 between the interface region 203 and the wet/dry cleaning region 205. The liquid containment region 207 includes a removable liquid containment reservoir 252 (“reservoir 252”) generally configured to be attached and detached to and from the body 202. The reservoir 252 may include clear/opaque window features 252 to enable users to view and assess the liquid contents inside the reservoir 252. The reservoir 252 may also include a locking mechanism 256 to enable users to unlock the reservoir 252 and remove from the body 202 and to lock the reservoir 252 to the body to prevent unintentional spilling of liquid held in the reservoir. In some embodiments, the reservoir 252 may be attached to the body 202 using mated threads. In other embodiments, the reservoir 252 may be attached to the body 202 using, for example, latches, snap-fit arrangements, bayonet tabs, etc. As a general matter, and as will be described below, the reservoir 252 is generally configured to contain liquid messes that are suctioned into the body, so that minimal liquid remains in airflow through the body 202 and out the interface region 203.

FIG. 2B illustrates a front perspective view of the containment tool 200 according to embodiments of the present disclosure. In this view, features of the wet/dry cleaning region 205 are illustrated. The wet/dry cleaning region 205 includes an elongated vacuum orifice 258 and an agitator assembly 260 generally disposed adjacent the vacuum orifice 258 on the underside of the body 202, and a fluid dispensing nozzle assembly 262 disposed in front of, and above, the vacuum orifice 258.

The vacuum orifice 258 is in fluid communication through the body 202 and to the opposing end of the body (in the interface region 203) so that when the tool 200 is coupled to another tool (which itself is coupled to vacuum source hose), suction is applied to the vacuum orifice 258. The opening of vacuum orifice 258 is depicted as having a generally elongated rectangular cross section, although in some embodiments the vacuum orifice may have a generally circular cross section, generally oval cross section, triangular cross section, rectangular cross section, etc. The agitator assembly 260 (similar to agitator assembly 106) generally includes a plurality of filaments (e.g., elongated filaments) extending from the body 202. The filaments may be formed of, for example, plastic, rubber, composite material, metal, metal composites, etc. In some embodiments, the plurality of filaments may be selected for a desired stiffness, length and/or density for a given cleaning task. Also, in some embodiments the agitator assembly 260 may be removably coupled to the body 202, thus allowing interchangeable agitator assemblies to be coupled to the body 202 for a given cleaning task. The nozzle assembly 262 generally includes a liquid spray nozzle, described in greater detail below.

FIG. 2C illustrates a front perspective and partially exploded view of the containment tool 200 according to embodiments of the present disclosure. In this view, the body includes a removable front panel 270. The removable front panel 270 may be removed to enable cleaning of the vacuum orifice 258 defined in the front of the body 202 between the front panel 270 and the wet/dry cleaning region 205. In this example, vacuum orifice 258 includes a tapered conduit that includes a flared portion 267 in an area near an opening of the vacuum orifice 258 tapered to a fluted portion 268. The taper from the flared portion 267 to the tapered portion 268 may provide increased airflow pressure (and velocity) as the airflow (which may contain liquid) enters the containment region 207. This may provide enhanced separation of liquid from air, where a majority of liquid is deposited into the reservoir 252, and thus “drier” air is passed through the remainder of the tool body 202. Of course, in other embodiments the vacuum orifice 258 may be formed with other shapes, for example, straight, partially tapered, etc.

FIG. 2D illustrates a back perspective view of the containment tool 200 according to embodiments of the present disclosure. In particular, this view illustrates the interface region 203 in greater detail. As a general matter, the interface region includes an opening 272 to receive a portion of a different tool (e.g., to receive the wet/dry region 105 of the crevice tool 100 described above), and includes interfaces to sealingly couple a vacuum source and a cleaning fluid source to the tool 200. Accordingly, the interface region 203 includes a tool interface that includes an abutment surface 283 around the periphery of the interface opening 272. The abutment surface 283 is dimensioned to sealingly couple to the abutment surface(s) 107 of the crevice tool 100 (FIG. 1A). The abutment surface 283 may include a gasket and/or rubber seal to provide a liquid and air seal when another (e.g., crevice tool 100, described above) tool is inserted into the opening 272.

The interface region 203 also includes a cleaning fluid interface shown generally at 284, and generally configured to sealingy couple to the nozzle assembly 108 of the crevice tool 100 to the tool 200. The cleaning fluid interface 284 includes an outer ring member 278 surrounding a gasket 277. A gap is defined between the outer ring 278 and the gasket 277 to receive and scalingly engage the outer flange ring 124 of the nozzle assembly 108 (FIG. 1D). The gasket 277 includes a central anulus 282 to sealingly receive the liquid nozzle 127 of the nozzle assembly 108 (FIG. 1D). The outer ring 278 is coupled to engagement lobes (one of which is illustrated at 281A). Engagement lobe 281A has a shape (e.g., triangular shape) to mate with the recess 112A of tool 100. Engagement lobe 281A and ring 278 are coupled to a spring (not shown in this figure) that biases the ring 278 and lobe 281A “upward”, i.e., biases toward the center of the interface region 203. As tool 100 is inserted into tool 100, the lobe 281A and ring 278 are pushed downward (i.e., away from the center of the interface region 203) until the recess 112A aligns with lobe 281A. The spring then causes the lobe 281A and ring 278 to urge upward and seal the flanged nozzle ring 124 between the gasket 277 and the ring 278. The cleaning fluid interface is generally configured to deliver cleaning fluid from the nozzle 108 of the first tool 100 to the nozzle 262 of the containment tool 200 (via embedded conduit channels, described below).

The interface region 203 also includes a vacuum interface 274 having sidewall portions 276 having a shape and orientation to mate with the periphery of the vacuum orifice 104 (FIG. 1A). On the exposed surface of the sidewall portions 276 (i.e., the surface that abuts the periphery of the vacuum orifice 104 (FIG. 1A) when tool 100 is inserted into the interface 203), a seal (e.g., gasket, rubber seal, etc.) may be provided to provide an air-tight coupling of the vacuum orifice 104 and the vacuum interface 274.

The interface region 203 also includes a latch engagement ridge 279 configured to engage and disengage with the latch 122 of the tool 100 (FIGS. 1B and 1F), thus securing the tool 100 to the tool 200. The interface region 203 may also include one or more channels (one of which is illustrated at 280) to receive rail 114A and/114B (of tool 100) to guide the insertion of tool 100 into tool 200, and to provide accurate coupling between tool 100 and tool 200 (i.e., to reduce or eliminate movement between the tools and thus reducing or eliminating vacuum pressure drop and/or liquid leakage at the interface 203).

FIG. 2E illustrates a back perspective and partial cut-away view of the containment tool 200 according to embodiments of the present disclosure. In particular, this figure illustrates the cleaning fluid interface 284 in greater detail. As illustrated, the engagement lobe 281A is coupled to outer ring 278, which are coupled to spring members 287A and 287B, respectively, the operation of which is described above. Spring member 287B coupled to the ring 278 and a corresponding lobe 281B (not shown in this figure). FIG. 2F illustrates another back perspective view of the containment tool 200 according to embodiments of the present disclosure. In particular, this figure illustrates the gasket 277 of the cleaning fluid interface 284 in greater detail. As illustrated, the central anulus 282 of the gasket 277 may be tapered to sealingly engage the nozzle 127 of the tool 100. The taper may be dimensioned based on the geometry of the nozzle 127. A screen 285 may be placed within the anulus 282 to prevent particulate matter from entering the nozzle of tool 200.

FIG. 2G illustrates another perspective side view of the containment tool 200, and FIG. 2H illustrates a cross-sectional view of the containment tool 200, taken along the line XI-XI in FIG. 2G. As illustrated in FIG. 2H, an airflow/liquid path (AF/L) is defined through the body 202, starting at the vacuum orifice 258. The cleaning tool 200 may be used to vacuum a variety of liquid messes, and thus, the airflow path (AH/L) may contain both air and liquid. Between the wet/dry cleaning region 205 and the containment region 207, a one-way valve 286 (e.g., duckbill valve, etc.) may be placed in the AF/L path to prevent liquid and/or air from entering the wet/dry cleaning region 205 from the containment region 207. Once cleared through the valve 286, the AF/L continues to the containment canister 252 (as illustrated by arrows in the AH/L path). As is illustrated, the containment canister 252 generally has a larger volume that the AF/L path in the wet/dry region 205, and thus the larger volume of the canister 252 causes a pressure drop in the vacuum pressure. As airflow and/or liquid enter the containment canister 252, liquid and denser solids in the airflow tend to drop into the canister 252, thus separating a majority of liquid/solids from air. The (drier) airflow (AF) continues up through the mesh body and through the interface 274 between the first tool 100 and the present tool 200.

The containment region 207 may also include an airflow director plate 288 disposed adjacent to the canister 252 generally configured to control a direction of airflow (AF/L and AF) through the canister 252. The airflow director plate 288 may include side lobes 290A and 290B on either side of the plate 288. Lobe 290A may extend downward from the plate toward the bottom of the canister 252, and may direct airflow in the AF/L path further downward into the canister. Lobe 290A may enhance separation of liquids and solids in the airflow to deposit into the canister 252. Lobe 290B is generally L-shaped may operate in a similar fashion as lobe 290A by directing the airflow so that the airflow spends more time in the canister 252, thus increasing the ability to remove liquids and/or solids from the airflow. The plate 288 may also include a mesh material 289 disposed in the center thereof. A bleed valve (e.g., umbrella valve, etc.) 292 may be provided to reduce vacuum pressure. As is illustrated, the bleed valve 292 permits ambient air to enter through a release path (R) and through the interface 274.

As is also illustrated in FIG. 2H, the cleaning fluid interface 284 may be fluidly coupled to a cleaning fluid conduit 295 (via couple 294) to deliver cleaning fluid from a cleaning fluid source and through the first tool 100 to the nozzle 262. It should be noted that actuation of cleaning fluid in the crevice tool 100 causes cleaning fluid to flow through the interface 284 and through the conduit 295 to the nozzle 262 of the present tool 200. Thus, delivery of cleaning fluid is controlled by the first tool 100. In this example, the conduit 295 extends from the bottom of the body 200 to the top of the body 200, and wraps around the airflow path.

FIG. 2I illustrates a bottom perspective view of the containment tool 200 according to other embodiments of the present disclosure. In particular, this figure illustrates the tool 200 with the canister 252 removed, and exposing an airflow director plate 288′ according to another embodiment of the present disclosure. The plate 288′ of this embodiment includes an L-shaped side lobe 290A′ generally dimensioned to cause redirection of the airflow (AF/L) toward the front of the body 202 before releasing the airflow into the canister. Lobe 290B′ includes a shroud portion to reduce or eliminate slosh (of liquid) from hitting the back wall of the canister and splashing back toward the mesh, thus reducing or eliminating liquid slosh from entering the mesh 289′ and getting sucked into the vacuum airflow.

FIG. 2J illustrates a side perspective view of the containment tool 200′ according to another embodiment of the present disclosure. In this embodiment, the removable front panel 270′ includes a flange portion 265 dimensioned to seat over the agitator assembly 260. The flange portion 265 provides a continuous cover over the agitator assembly 260 and the vacuum orifice 258 at the wet/dry cleaning region 205′ of the body 202′ to prevent buildup of dirt and debris around the vacuum orifice 258. The removable front panel 270′ may be formed of, for example, clear/transparent materials such as plastics, fiberglass, etc., to enable a user to assess buildup of dirt and debris behind the front panel 270′. Removing the front cover 270′ including the flange portion 265 allows any dirt/debris around the vacuum orifice 258 and/or agitator assembly 260 to “drop away” from the body 202′, as described below.

The removable front cover 270′ includes an upper tab portion 221 configured to mate with a shoulder portion 222 of the body 202′. The tab portion 221 and shoulder portion 222 may couple together in a “snap-fit” arrangement, thus allowing the front cover 270′ to be removed from the body 202′. The front cover 270′ also defines an opening 223 to receive the nozzle assembly 262. FIG. 2K illustrates a side perspective view of the containment tool 200′, with the removable front cover 270′ removed from the body 202′. As illustrated, the flange portion 265 of the front cover 270′ includes a plurality of holes or openings dimensioned to receive the filaments associated with the agitator assembly 260. In one embodiment, an unobstructed opening 225 is provided that corresponds to the vacuum orifice 258.

As is illustrated, the internal and external structures of the body 202/202′ includes various slots, channels and/or chambers to define airflow paths described above (e.g., AF/L path, AF path, R path) and to affix and/or house the cleaning fluid interface 284, conduit 295, couple 294, plate 288, valves 286 and 292, airflow interface 274, nozzle 262, etc. within the body 202. Of course, such slots, channels and/or chambers to define paths and to affix and/or house components within the body may be modified, for example, depending on dimensions of selected components, desired tolerances within the body and between components, etc.

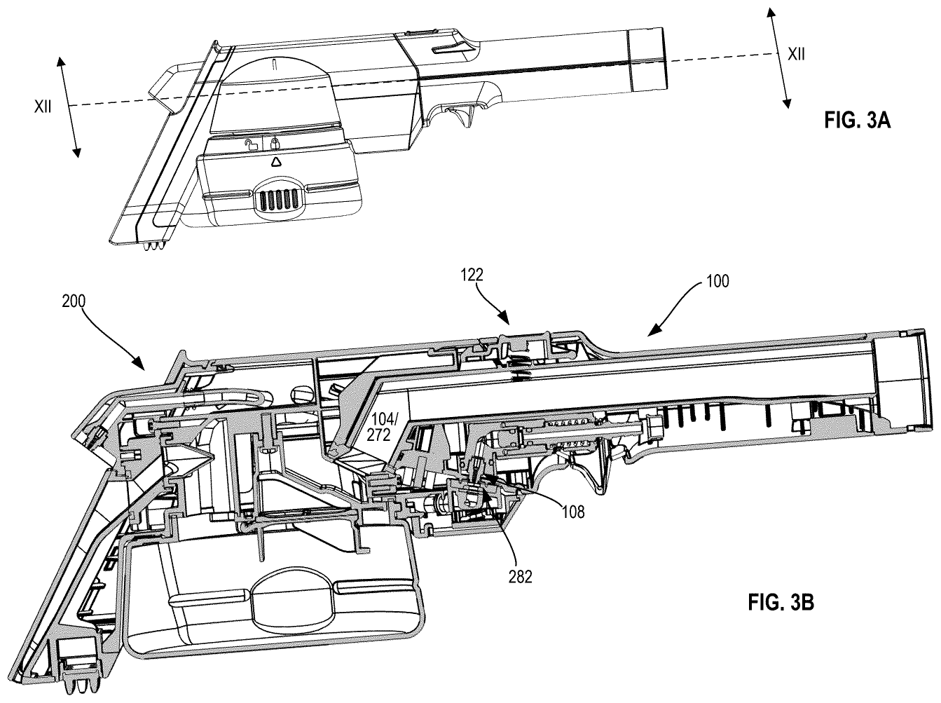

FIG. 3A illustrates a perspective side view of a cooperating tool set 300, and FIG. 3B illustrates a cross-sectional view of the cooperating tool set 300, taken along the line XI-XI in FIG. 3A. As illustrated in FIG. 3A, the cooperating tool includes the crevice tool 100 inserted into (and removably coupled from) the containment tool 200, thus providing a liquid containment tool that can be used for a variety of cleaning tasks. As noted above, the crevice tool 100 may operate independently of the containment tool 200, and the crevice tool 100 provides cleaning fluid and vacuum airflow for the containment tool 200 when coupled together as illustrated.

The cross-sectional view of FIG. 3B illustrates coupling between the nozzle assembly 108 (tool 100) and the nozzle interface 284 (tool 200), coupling between the vacuum orifice 104 (tool 100) and the vacuum interface 272 (tool 200). The cross-sectional view of FIG. 3B also illustrates the latch 122 to securely and removably couple tool 100 to tool 200.

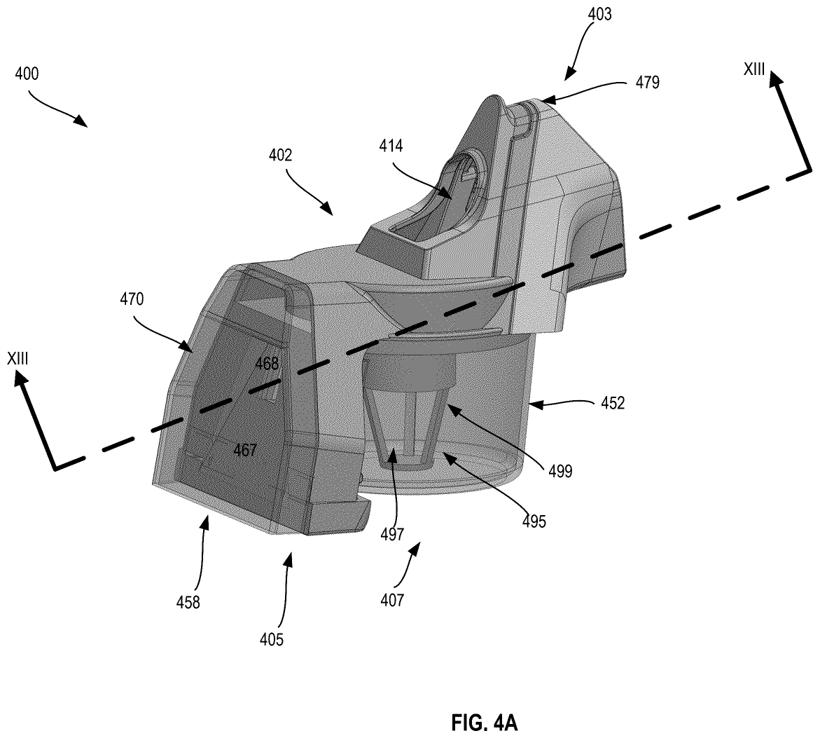

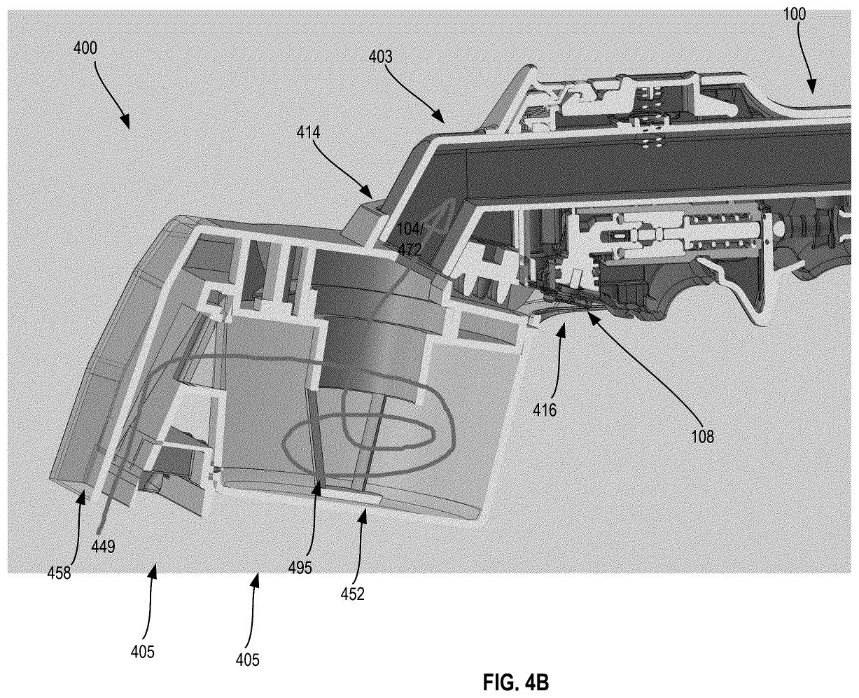

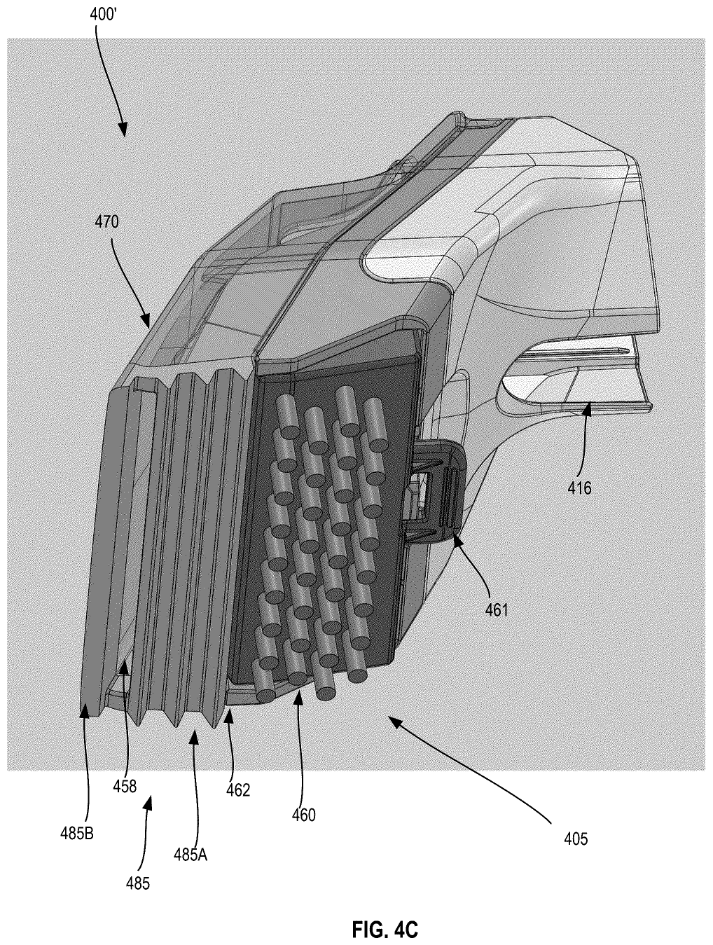

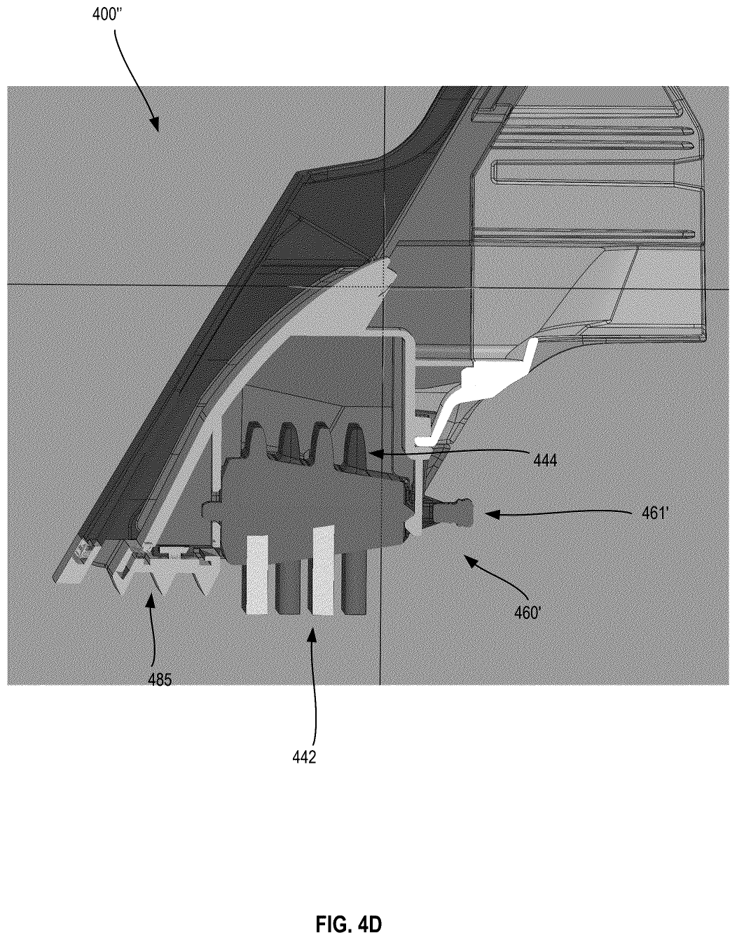

FIG. 4A illustrates a perspective side view of another containment tool 400 according to embodiments of the present disclosure. As a general matter, the containment tool 400 of FIG. 4 is configured to engage over a portion of the crevice tool 100 of FIG. 1 (described above), thus providing a cooperating tool set for a variety of wet/dry cleaning tasks. The containment tool 400 generally includes a body 402 that includes an interface region 403 on one end of the body 402, a wet/dry cleaning region 405 on an opposing end of the body 402, and a wet/dry containment region 407 between the interface region 403 and the wet/dry cleaning region 405. The wet/dry containment region 407 includes a removable containment reservoir 452 (“reservoir 452”) generally configured to be attached and detached to and from the body 402. The reservoir 452 may be formed of clear/transparent materials to enable users to view and assess the liquid or dry contents inside the reservoir 452. The reservoir 452 may also include a locking mechanism to enable users to unlock the reservoir 452 and remove from the body 402 and to lock the reservoir 452 to the body to prevent unintentional spilling of liquid held in the reservoir. In some embodiments, the reservoir 452 may be attached to the body 402 using mated threads. In other embodiments, the reservoir 452 may be attached to the body 402 using, for example, latches, snap-fit arrangements, bayonet tabs, etc. As a general matter, and as will be described below, the reservoir 452 is generally configured to contain both liquid and dry messes that are suctioned into the body. Thus, unlike the embodiment of FIGS. 2A-2I, the tool 400 of this embodiment is designed to deposit both liquid and dry messes into the reservoir 452 via a single wet/dry path through the body 402, as described below.

The vacuum orifice 458 is in fluid communication through the body 402 and to the opposing end of the body (in the interface region 403) so that when the tool 400 is coupled to another tool (which itself is coupled to vacuum source hose), suction is applied to the vacuum orifice 458. The opening of vacuum orifice 458 is depicted as having a generally elongated rectangular cross section, although in some embodiments the vacuum orifice may have a generally circular cross section, generally oval cross section, triangular cross section, rectangular cross section, etc. An agitator assembly slot 461 is dimensioned to receive an agitator assembly, such the agitator assembly 260 (described above).

The body 402 includes a removable front panel 470, as described above in FIGS. 2J and 2K. The removable front panel 470 may be removed to enable cleaning of the vacuum orifice 458 defined in the front of the body 402 between the front panel 470 and the wet/dry cleaning region 405. The removable front panel 470 may be clear or transparent to enable direct viewing of the region behind the front panel 470. In this example, the vacuum orifice 458 includes a tapered conduit that includes a flared portion 467 in an area near an opening of the vacuum orifice 458 tapered to a fluted portion 468. The taper from the flared portion 467 to the tapered portion 468 may provide increased airflow pressure (and velocity) as the airflow (which may contain liquid) enters the containment region 407. Of course, in other embodiments the vacuum orifice 458 may be formed with other shapes, for example, straight, partially tapered, etc.

The interface region 403 also includes a latch engagement ridge 479 configured to engage and disengage with the latch 122 of the tool 100 (FIGS. 1B and 1F), thus securing the tool 100 to the tool 400. The interface region 403 may also include one or more channels (to receive rail 114A and/114B (of tool 100) to guide the insertion of tool 100 into tool 400, and to provide accurate coupling between tool 100 and tool 400 (i.e., to reduce or eliminate movement between the tools and thus reducing or eliminating vacuum pressure drop and/or liquid leakage at the interface 403). The interface region 403 also defines an opening 414 to receive a portion of the hand tool 100, as described below.

The containment region 407 also includes a filter assembly 495 disposed within the reservoir 452 and within a wet/dry airflow path such that both wet and dry messes drawn through the vacuum orifice 458 are passed through the filter assembly 495. The filter assembly 495 includes a generally conically-shaped frame 499 and a filter material 497 disposed over a majority of the frame 499. The filter material 497 may be formed of, for example, composite materials, paper, cloth, stainless steel mesh, etc., and may be removable from the frame 499 for cleaning/replacement, etc. The filter assembly 495 may be removably affixed to the body 402 in the containment region 407 in a screw-type fashion, snap-fit cooperations, and/or other mechanisms to allow a user to remove and install the filter assembly 495.

FIG. 4B illustrates a cross-sectional view of the containment tool 400, taken along the line XIII-XIII in FIG. 4A, according to embodiments of the present disclosure. In addition, FIG. 4B illustrates a cooperating tool set in which tool 100 is removably coupled to the interface region 403 of the tool 100, similar to the embodiments of FIGS. 3A and 3B. As noted above, the crevice tool 100 may operate independently of the containment tool 400, and the crevice tool 100 provides cleaning fluid and vacuum airflow for the containment tool 400 when coupled together as illustrated.

Tool 100 is inserted into the interface region 403 so that a portion of the suction interface 104 extends through the opening 414, as illustrated. Thus, an suction airflow path 449 defined from the vacuum orifice 458, through the reservoir 452 and filter assembly 495 and out through the interface 104/472. The conical shape of the frame 499 generally causes an airflow pattern having a swirling or vortex effect, as illustrated by the suction airflow path 499 of FIG. 4B. The tool 100 may be coupled to a vacuum system that may include cleaning fluid supply and a dirty water tank, described below. Thus, both wet and dry messes contained, at least partially, in the reservoir 452. A slot 416 is defined by the structure of the interface region 403 to receive the nozzle assembly 108 while leaving the nozzle assembly 108 exposed exterior to the tool 400.

FIG. 4C illustrates a bottom perspective view of a containment tool 400′ according to one embodiment. In this embodiment, the containment tool 400′ is similar to the tool 400 described above. In this embodiment, the wet/dry cleaning region 405 includes a pet hair removal assembly 485 generally disposed around the suction inlet 458, and adjacent to the agitator assembly 460. In embodiments, the pet hair removal assembly includes a plurality of first ribs 485A disposed adjacent the agitator assembly 460. The first plurality of ribs 485A are disposed generally parallel to the suction inlet 458 in the space between the suction inlet 458 and the agitator assembly 460. At least one second rib 485B is disposed on a leading edge 459 of the cover 470 so that the suction inlet 458 is surrounded by the assembly 485. When agitated against a surface containing hair, the ribs 485A/485B of the pet hair removal assembly 485 tend to cause hair to be forced into the suction inlet 458 for removal. In addition, the ribs 485A/485B are particularly useful in removing hair from difficult surfaces, e.g., hair embedded into carpet, cloth, etc. The pet hair removal assembly 485 may be formed of, for example, plastic, rubber, composite material, metal, metal composites, etc. In some embodiments, the ribs 485A/485B of the pet hair removal assembly 485 may be selected for a desired stiffness, length, depth, and/or density for a given cleaning task. Also, in some embodiments the pet hair removal assembly 485 may be removably coupled to the body 402, thus allowing interchangeable pet hair assemblies to be coupled to the body 402 for a given cleaning task.

The agitator assembly 460 (similar to agitator assembly 106, 260) generally includes a plurality of filaments (nubbins) extending from the body 402. The agitator assembly may be coupled to the body 402, for example, via a snap fit tab 461 or the like. The nubbins may be formed of, for example, plastic, rubber, composite material, metal, metal composites, etc. In some embodiments, the plurality of nubbins may be selected for a desired stiffness, length and/or density for a given cleaning task. Also, in some embodiments the agitator assembly 460 may be removably coupled to the body 402, thus allowing interchangeable agitator assemblies to be coupled to the body 402 for a given cleaning task. To reduce or eliminate build up of dirt and debris collecting near the wet/dry cleaning region 405, the agitator assembly 460 and pet hair removal assembly 485 may be dimensioned so that a gap 462 between the agitator assembly 460 and pet hair removal assembly 485 is reduced or eliminated.

FIG. 4D illustrates a cross sectional view of another embodiment of the containment tool 400″. In this embodiment, the agitator assembly 460′ includes a double-sided assembly including a first set of agitating nubbins (or filaments or tufted bristles, etc.) 442 disposed on a first side of the assembly 460′ and a second set of agitating nubbins 444 disposed on a second opposing side of the assembly 460′. As described above, the agitator assembly 460′ may be removably coupled to the body 402, via, for example tab 461′. The nubbins 442 may differ from the nubbins 444, thus allowing a user to select an appropriate nubbin length and/or stiffness for a given cleaning task

As is illustrated, the internal structure of the body 402 includes various slots, channels and/or chambers to define airflow paths described above (e.g., wet/dry suction path 449) and to affix and/or house the components described above within the body 402. Of course, such slots, channels and/or chambers to define paths and to affix and/or house components within the body may be modified, for example, depending on dimensions of selected components, desired tolerances within the body and between components, etc.

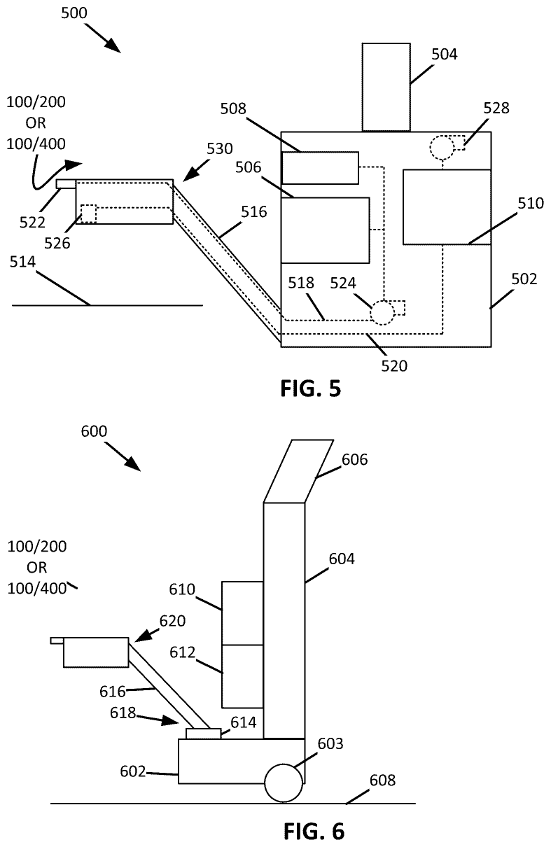

As described above, the crevice tool 100/may be coupled to a vacuum source and cleaning fluid source, depending on the types of cleaning tasks to be performed. Accordingly, FIG. 5 illustrates a schematic example of a handheld extraction cleaner 500 consistent with embodiments of the present disclosure. As shown, the handheld extraction cleaner 500 includes a cleaner body 502, a carry handle 504 for carrying the cleaner body 502, a supply tank 506 configured for receiving a first cleaning fluid, an additive tank 508 configured for receiving a second cleaning fluid, a recovery tank 510. The cleaning tool 100 and/or tool set 100/200 and/or tool set 100/400 (described above) is configured to dispense the first and/or second cleaning fluids onto a surface to be cleaned 514 and to extract at least a portion of the first and/or second dispensed cleaning fluids. The extracted first and/or second cleaning fluid may be conveyed into the recovery tank (e.g., dirty water tank) 510 for collection and later disposal.

In some embodiments, the second cleaning fluid may include a boost fluid mixed with a base cleaning fluid. The boost fluid may include, for example, an oxide such as hydrogen peroxide. The base cleaning fluid may include, for example, water, detergent, soap, a fragrance, and/or other cleaning fluid. The boost fluid may have a pH (potential of hydrogen) that is less than the pH of the base cleaning fluid to prevent breakdown of the boost fluid in the second cleaning fluid. In some embodiments, for example, the pH of the boost fluid may be less than or equal to about 4.5 and the pH of the base cleaning fluid may be greater than or equal to about 9. Use of a boost fluid in the second cleaning fluid may be particularly useful when cleaning using the cleaning tool 100 and/or tool set 100/200 and/or tool set 100/400, e.g., to clean a heavily soiled target area.

As shown, a flexible hose 516 couples the cleaning tools or tool sets described herein to the cleaner body 502 of the handheld extraction cleaner 500. The flexible hose 516 may include a fluid delivery pathway 518 (e.g., one or more delivery tubes) that extends within a recovery pathway 520 defined within the flexible hose 516.

The fluid delivery pathway 518 fluidly couples the wet/dry tools described herein to the supply and additive tanks 506 and/or 508. The cleaning tool or tool sets described herein can be configured to selectively fluidly couple the fluid applicator 522 of the cleaning tool or tool sets described herein to the fluid delivery pathway 518 (e.g., such that a user can control the delivery of the first cleaning fluid, the second cleaning fluid, and/or a mixture of the first and second cleaning fluids to the surface to be cleaned 514). In some instances, the additive tank 508 may be selectively fluidly coupled to the cleaning tool 512 (e.g., such that the first and second cleaning fluids may be selectively applied as a mixture). The handheld extraction cleaner 500 may include a pump 524 (e.g., the cleaner body 502 includes the pump 524) fluidly coupled to the fluid delivery pathway 518 at a location downstream of at least one of the supply and/or additive tanks 506 and/or 508 and upstream of the fluid applicator 522 of the cleaning tools and/or tool sets described herein. As such, the pump 524 can be generally described as being configured to urge the first and/or second cleaning fluids through the fluid applicator 522 to be dispensed on the surface to be cleaned 414. In some instances, the handheld extraction cleaner 500 may be configured to deliver only the first cleaning fluid, only the second cleaning fluid, and/or a combination of the first and second cleaning fluids. For example, a user of the handheld extraction cleaner may be able to select between delivering only the first cleaning fluid, only the second cleaning fluid, or a combination of the first and second cleaning fluids to the surface to be cleaned 514. By way of further example, the handheld extraction cleaner 500 may be configured to deliver only a combination of the first and second cleaning fluids to the surface to be cleaned 514. In this example, the handheld extraction cleaner 500 may be configured to deliver the combination of the first and second cleaning fluids until at least one of the first and/or second cleaning fluids is depleted. Alternatively, in this example, when one of the first or second cleaning fluids is depleted, the other of the first or second cleaning fluids may continue to be delivered to the surface to be cleaned 514 until depleted.

At least a portion of any debris on the surface to be cleaned 514 becomes entrained within the dispensed first and/or second cleaning fluids. When debris becomes entrained within the first and/or second cleaning fluids, the resulting mixture may generally be referred to as dirty cleaning fluid. The recovery pathway 520 defined within the flexible hose 516 fluidly couples the cleaning tools or tool sets described herein (e.g., a suction inlet 120 of the cleaning tool 100) to the recovery tank 510. For example, the handheld extraction cleaner 500 may include a suction motor 528 (e.g., the cleaner body 502 includes the suction motor 528) fluidly coupled to the recovery pathway 520 and the recovery tank 510 such that the suction motor 528 generates an airflow that extracts at least a portion of the dispensed first and/or second cleaning fluids from the surface to be cleaned 514 (e.g., using the suction inlet 120). At least a portion of the extracted cleaning fluid is deposited within the recovery tank 510.

As another example of the types of cleaning system that may be used with cleaning tools described herein, FIG. 6 illustrates a schematic example of an upright extraction cleaner 600 consistent with embodiments of the present disclosure. The upright extraction cleaner 600 includes a surface cleaning head 602, at least one wheel 603 rotatably coupled the surface cleaning head 602, and an upright body 604 including a handle 606. The upright body 604 is pivotally coupled to the surface cleaning head 602 such that the upright body 604 transitions between an in-use and a storage position in response to pivotal movement of the upright body 604. A user may interact with the handle 606 to maneuver the surface cleaning head 602 along a surface to be cleaned 608. The upright extraction cleaner 600 includes at least one supply tank 610 and a recovery tank 612. At least one of the supply tank 610 and recovery tank 612 are removably coupled to the upright body 604. At least one of the upright body 604 and/or the surface cleaning head 602 includes a flexible hose connector 614 configured to removably couple to a flexible hose 616. The flexible hose 616 includes a cleaner end 618 configured to removably couple to the flexible hose connector 614 and an accessory end 620 configured to removably couple to, for example, the cleaning tools and/or tool sets described herein.

Accordingly, in one example embodiment the present disclosure provides a wet/dry containment vacuum tool for cooperating with a different wet/dry vacuum tool, the wet/dry containment vacuum tool comprising: a tool body comprising: an interface region, the interface region comprising: a tool interface surface to mate with an abutment surface of the different wet/dry vacuum tool; a cleaning fluid interface comprising a slot; wherein the slot is configured to receive a nozzle associated with the different wet/dry vacuum tool; and a vacuum interface to sealingly mate with a vacuum orifice associated with the different wet/dry vacuum tool; and a wet/dry cleaning region, the wet/dry cleaning region comprising: a vacuum orifice fluidly coupled through the body to the vacuum interface; and a containment region disposed between the wet/dry cleaning region and the interface region, the containment region comprising: a removable reservoir coupled to the body; wherein the body defining a wet/dry airflow suction path from the wet/dry cleaning region, through the removable reservoir and through the interface region; and wherein the removable reservoir to receive solids and liquids contained within the wet/dry airflow suction path.

In another example embodiment the present disclosure provides A wet/dry containment vacuum tool for cooperating with a different wet/dry vacuum tool, the wet/dry containment vacuum tool comprising: a tool body comprising: an interface region, the interface region comprising: a tool interface surface to mate with an abutment surface of the different wet/dry vacuum tool; a cleaning fluid interface comprising a ring member and an annular gasket, the ring member surrounding and spaced from the annular gasket; wherein the annular gasket is configured to sealingly receive a nozzle associated with the different wet/dry vacuum tool; and a vacuum interface to sealingly mate with a vacuum orifice associated with the different wet/dry vacuum tool; and a wet/dry cleaning region, the wet/dry cleaning region comprising: a cleaning fluid nozzle fluidly coupled to the cleaning fluid interface; a vacuum orifice fluidly coupled through the body to the vacuum interface; an agitator assembly removably coupled to the wet/dry cleaning region of the body, the agitator assembly including a plurality of nubbins extending from the body; and a removable cover disposed over the cleaning fluid nozzle and vacuum orifice; the removable cover include a perforated flange portion to cover the agitator assembly and wherein the nubbins extending through the perforations in the flange portion; and a containment region disposed between the wet/dry cleaning region and the interface region, the containment region comprising: a removable canister coupled to the body, the canister to receive liquid and/or solids in an airflow path defined between the vacuum orifice and the vacuum interface.

In another example embodiment the present disclosure provides a cooperating wet/dry vacuum tool set, comprising: a first tool, the first tool having a first tool body including a grip region, the grip region is configured to couple to a vacuum source and a cleaning fluid source; the first tool body further including a wet/dry cleaning region disposed opposite the grip region end; the wet/dry cleaning region includes: a cleaning fluid nozzle assembly including a fluid nozzle and a flanged ring surrounding the fluid nozzle, wherein the fluid nozzle is fluidly coupled to the cleaning fluid source; a controllable fluid delivery actuator to controllably couple and decouple the cleaning fluid source from the fluid nozzle; a vacuum orifice fluidly coupled through the body to the vacuum source; and an agitator assembly removably coupled to the wet/dry cleaning region of the body, the agitator assembly including a plurality of nubbins extending from the body; and a second tool, the second tool having a second tool body that includes an interface region, a second wet/dry cleaning region and a containment region disposed between the wet/dry cleaning region and the interface region, wherein: the interface region comprising: a tool interface surface to mate with an abutment surface of the first tool; a cleaning fluid interface comprising a slot; wherein the slot is configured to receive a nozzle associated with the first tool; and a vacuum interface to sealingly mate with a vacuum orifice associated with the first tool; and a wet/dry cleaning region, the wet/dry cleaning region comprising: a vacuum orifice fluidly coupled through the body to the vacuum interface; and a containment region disposed between the wet/dry cleaning region and the interface region, the containment region comprising: a removable reservoir coupled to the body; wherein the body defining a wet/dry airflow suction path from the wet/dry cleaning region, through the removable reservoir and through the interface region; and wherein the removable reservoir to receive solids and liquids contained within the wet/dry airflow suction path.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A wet/dry containment vacuum tool for cooperating with a different wet/dry vacuum tool, the wet/dry containment vacuum tool comprising:
a tool body comprising:
an interface region, the interface region comprising:
a tool interface surface to mate with an abutment surface of the different wet/dry vacuum tool;
a cleaning fluid interface comprising a slot; wherein the slot is configured to receive a nozzle associated with the different wet/dry vacuum tool; and
a vacuum interface to sealingly mate with a vacuum orifice associated with the different wet/dry vacuum tool; and
a wet/dry cleaning region, the wet/dry cleaning region comprising:
a vacuum orifice fluidly coupled through the body to the vacuum interface; and
a containment region disposed between the wet/dry cleaning region and the interface region, the containment region comprising:
a removable reservoir coupled to the body; wherein the body defining a wet/dry airflow suction path from the wet/dry cleaning region, through the removable reservoir and through the interface region; and wherein the removable reservoir to receive solids and liquids contained within the wet/dry airflow suction path.

2. The wet/dry containment vacuum tool of claim 1, wherein the containment region further comprising a filter assembly dimensioned to fit within the removable reservoir and in fluid communication with the wet/dry airflow suction path.

3. The wet/dry containment vacuum tool of claim 2, wherein the filter assembly includes a frame member and filter material at least partially surrounding the frame; wherein the filter assembly having a generally conical shape to cause airflow in the wet/dry airflow suction path to have a swirling motion within the removable reservoir.

4. The wet/dry containment vacuum tool of claim 1, further comprising:
an agitator assembly removably coupled to wet/dry cleaning region of the body, the agitator assembly extending from the body.

5. The wet/dry containment vacuum tool of claim 4, wherein the agitator assembly including a first set of agitating nubbins disposed on a first side of the agitator assembly and a second set of agitating nubbins disposed on a second opposing side of the agitator assembly.

6. The wet/dry containment vacuum tool of claim 1, further comprising:
a pet hair removal assembly removably coupled to wet/dry cleaning region of the body, the pet hair removal assembly including a plurality of ribs disposed around the vacuum orifice.

7. A wet/dry containment vacuum tool for cooperating with a different wet/dry vacuum tool, the wet/dry containment vacuum tool comprising:
a tool body comprising:
an interface region, the interface region comprising:
a tool interface surface to mate with an abutment surface of the different wet/dry vacuum tool;
a cleaning fluid interface comprising a ring member and an annular gasket, the ring member surrounding and spaced from the annular gasket; wherein
the annular gasket is configured to sealingly receive a nozzle associated with the different wet/dry vacuum tool; and
a vacuum interface to sealingly mate with a vacuum orifice associated with the different wet/dry vacuum tool; and
a wet/dry cleaning region, the wet/dry cleaning region comprising:
a cleaning fluid nozzle fluidly coupled to the cleaning fluid interface;
a vacuum orifice fluidly coupled through the body to the vacuum interface;
an agitator assembly removably coupled to the wet/dry cleaning region of the body, the agitator assembly including a plurality of nubbins extending from the body; and
a removable cover disposed over the cleaning fluid nozzle and vacuum orifice; the removable cover include a perforated flange portion to cover the agitator assembly and wherein the nubbins extending through the perforations in the flange portion; and
a containment region disposed between the wet/dry cleaning region and the interface region, the containment region comprising:
a removable canister coupled to the body, the canister to receive liquid and/or solids in an airflow path defined between the vacuum orifice and the vacuum interface.

8. The wet/dry containment vacuum tool of claim 7, wherein the agitator assembly including a first set of agitating nubbins disposed on a first side of the agitator assembly and a second set of agitating nubbins disposed on a second opposing side of the agitator assembly.

9. The wet/dry containment vacuum tool of claim 7, further comprising:
an airflow director plate disposed adjacent the removable canister within the body, the airflow director plate to direct airflow in the airflow path toward a bottom end of the canister.

10. The wet/dry containment vacuum tool of claim 9, wherein the airflow director plate comprises a first lobe for directing airflow from the vacuum orifice toward the bottom end of the canister, and a second lobe to direct airflow from the canister to the vacuum interface.

11. The wet/dry containment vacuum tool of claim 7, wherein the cleaning fluid interface is also configured to receive a flange ring member associated with the different wet/dry tool, the flange ring member to be sealingly received in the space between the ring member and the annular gasket.

12. The wet/dry containment vacuum tool of claim 7, further comprising:
a hook disposed within the interface region, the hook configured to controllably couple and decouple the wet/dry containment vacuum tool to and from the different wet/dry vacuum tool.

13. A cooperating wet/dry vacuum tool set, comprising:
a first tool, the first tool having a first tool body including a grip region, the grip region is configured to couple to a vacuum source and a cleaning fluid source;
the first tool body further including a wet/dry cleaning region disposed opposite the grip region end; the wet/dry cleaning region includes:
a cleaning fluid nozzle assembly including a fluid nozzle and a flanged ring surrounding the fluid nozzle, wherein the fluid nozzle is configured to fluidly coupled to the cleaning fluid source;
a controllable fluid delivery actuator to controllably couple and decouple the cleaning fluid source from the fluid nozzle;
a vacuum orifice fluidly coupled through the body to the vacuum source; and
an agitator assembly removably coupled to the wet/dry cleaning region of the body, the agitator assembly including a plurality of nubbins extending from the body; and
a second tool, the second tool having a second tool body that includes an interface region, a second wet/dry cleaning region and a containment region disposed between the wet/dry cleaning region and the interface region, wherein:
the interface region comprising:
a tool interface surface to mate with an abutment surface of the first tool;
a cleaning fluid interface comprising a slot; wherein the slot is configured to receive a nozzle associated with the first tool; and
a vacuum interface to sealingly mate with a vacuum orifice associated with the first tool; and
a wet/dry cleaning region, the wet/dry cleaning region comprising:
a vacuum orifice fluidly coupled through the body to the vacuum interface; and
a containment region disposed between the wet/dry cleaning region and the interface region, the containment region comprising:
a removable reservoir coupled to the body; wherein the body defining a wet/dry airflow suction path from the wet/dry cleaning region, through the removable reservoir and through the interface region; and wherein the removable reservoir to receive solids and liquids contained within the wet/dry airflow suction path.

14. The cooperating wet/dry vacuum tool set of claim 13, wherein the containment region further comprising a filter assembly dimensioned to fit within the removable reservoir and in fluid communication with the wet/dry airflow suction path.

15. The cooperating wet/dry vacuum tool set of claim 14, wherein the filter assembly includes a frame member and filter material at least partially surrounding the frame; wherein the filter assembly having a generally conical shape to cause airflow in the wet/dry airflow suction path to have a swirling motion within the removable reservoir.

16. The cooperating wet/dry vacuum tool set of claim 13, further comprising:
an agitator assembly removably coupled to wet/dry cleaning region of the body second tool, the agitator assembly extending from the body of the second tool.

17. The cooperating wet/dry vacuum tool set of claim 16, wherein the agitator assembly including a first set of agitating nubbins disposed on a first side of the agitator assembly and a second set of agitating nubbins disposed on a second opposing side of the agitator assembly.

18. The wet/dry containment vacuum tool of claim 1, further comprising:
a pet hair removal assembly removably coupled to wet/dry cleaning region of the second tool, the pet hair removal assembly including a plurality of ribs disposed around the vacuum orifice.
